(19) United States
(12) Patent Application Publication
(10) Pub. No.: US 2014/0025439 A1
(43) Pub. Date: Jan. 23, 2014

(54) REGRESSION FREE BUSINESS PROCESS MANAGEMENT

(71) Applicants: NIKOLAY KABADZHOV, Sofia (BG); Kristiyan Marinov, Sofia (BG)

(72) Inventors: NIKOLAY KABADZHOV, Sofia (BG); Kristiyan Marinov, Sofia (BG)

(21) Appl. No.: 13/550,642

(22) Filed: Jul. 17, 2012

(51) Int. Cl. G06Q 10/06

(52) U.S. Cl. 705/7.37

(57) ABSTRACT

After applying changes to a business process, a regression testing is performed by validating previously executed successful scenarios and checking for their consistency. The validation is done by checking if for specific input data, the business process transitions through all intermediate states specific to the input data in an exact order.

### FIELD

The field relates to testing of business process application. More precisely, the field relates to regression testing of business process applications.

### BACKGROUND

Business processes cover a great number of day-to-day business activities. Business process applications are commonly used to perform such activities and these applications are widely used in today's business life. Being widely used, business processes are very dynamic, which requires frequent adaptations. Some functionality may become obsolete and unnecessary, while new functionalities may be required by the business. Adaptations may also be triggered due to bad performance, errors, etc., which is part of a trivial maintenance of a business process application. “Regression testing” is a term used for checking the functional correctness of a business process application according to its specification, when a change to the business process is incorporated such as an enhancement, a patch or configuration changes. No matter the nature of the changes to a business process, a change always requires testing of the functionalities, both new and previously presented. A straight forward check is to test the performance of a new functionality and validation of the intended features according to specifications. However, a test is also needed to validate whether anew functionality affects all other old features in some unexpected way and that the business process application is error free and reliable as a whole. The validation of the whole business process application requires rigorous testing.

Due to the complex nature of a business process application, which includes external environment conditions, setting a test environment for all cases described in the specification to the business process is very complicated and time consuming. A common problem is when a test case requires any kind of human interaction. Human interactions are hard to be automated, because they are user interface specific. Although some user interface automation tools exist to mimic a human behavior and inputs, even a small change in the used user interface requires adaptations to the user interface automation tool as well. Making adaptations to a user interface automation tool, due to changes of a user interface, is also a complex and time-consuming task.

### SUMMARY

Various embodiments of systems and methods for regression free business process management are described herein. In one embodiment, the method includes receiving an initial definition of the business process and executing at least one business process scenario for the business process. The method also includes recording the at least one business process scenario for the business process and applying a change to the business process updating the initial definition of the business process. The method further includes validating the business process by replaying the recorded at least one business process scenario.

In other embodiments, the system includes a processor for executing program code and memory in communication with the processor. The system also includes a receiving module within the memory to receiving an initial definition of the business process and an executing module within the memory to execute at least one business process scenario for the business process. The system further includes a recording module within the memory to record the at least one business process scenario for the business process and a fixing module within the memory to apply a change to the business process to update the initial definition of the business process. The system also includes a validating module within the memory to validate the business process by replaying the recorded at least one business process scenario.

These and other benefits and features of embodiments will be apparent upon consideration of the following detailed description of preferred embodiments thereof, presented in connection with the following drawings.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1A is a block diagram of an embodiment of a business process for a purchase order approval.

FIG. 1B is a block diagram of an embodiment of an improved business process for a purchase order approval.

FIG. 1C is a block diagram of an embodiment of a complex business process for a purchase order approval.

FIG. 2A is a flow diagram of an embodiment of a method for regression testing of a business process.

FIG. 2B is a flow diagram of an embodiment of a method for recording a business process scenario for regression testing.

FIG. 3 is a block diagram of an embodiment of a system for regression testing of a business process.

FIG. 4 is a block diagram illustrating a computing environment in which the techniques described for regression testing of a business process can be implemented, according to an embodiment.

### DETAILED DESCRIPTION

Embodiments of techniques for regression free business process management are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

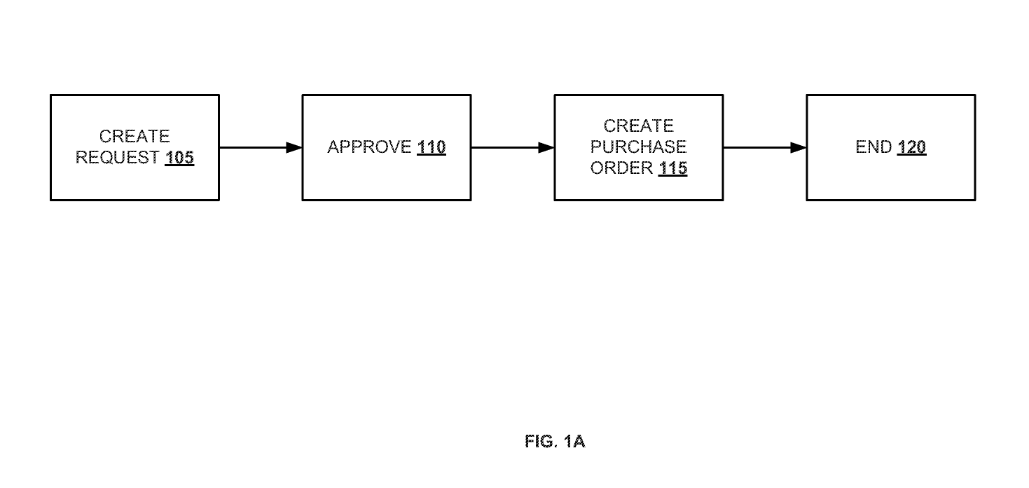

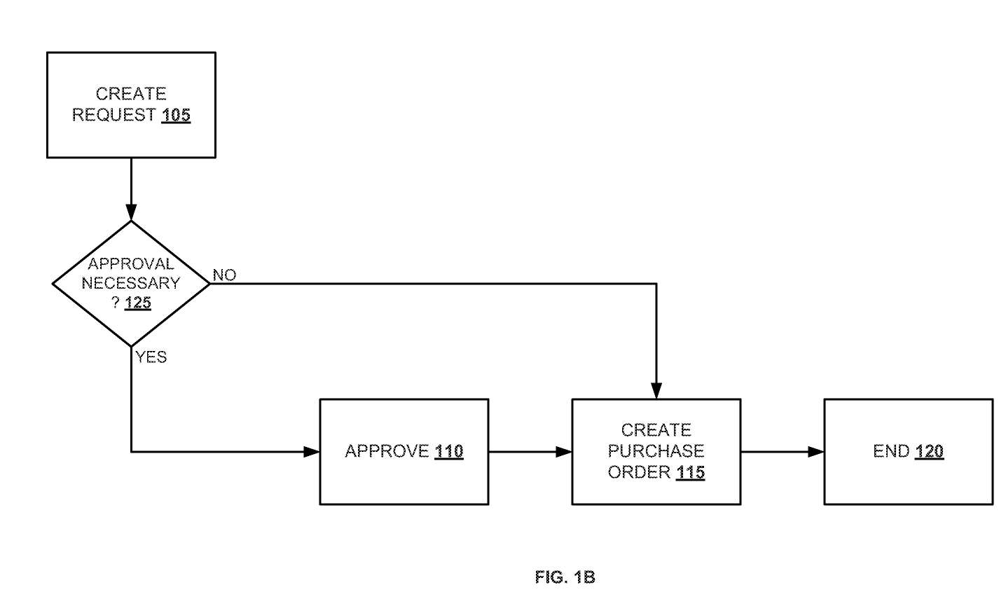

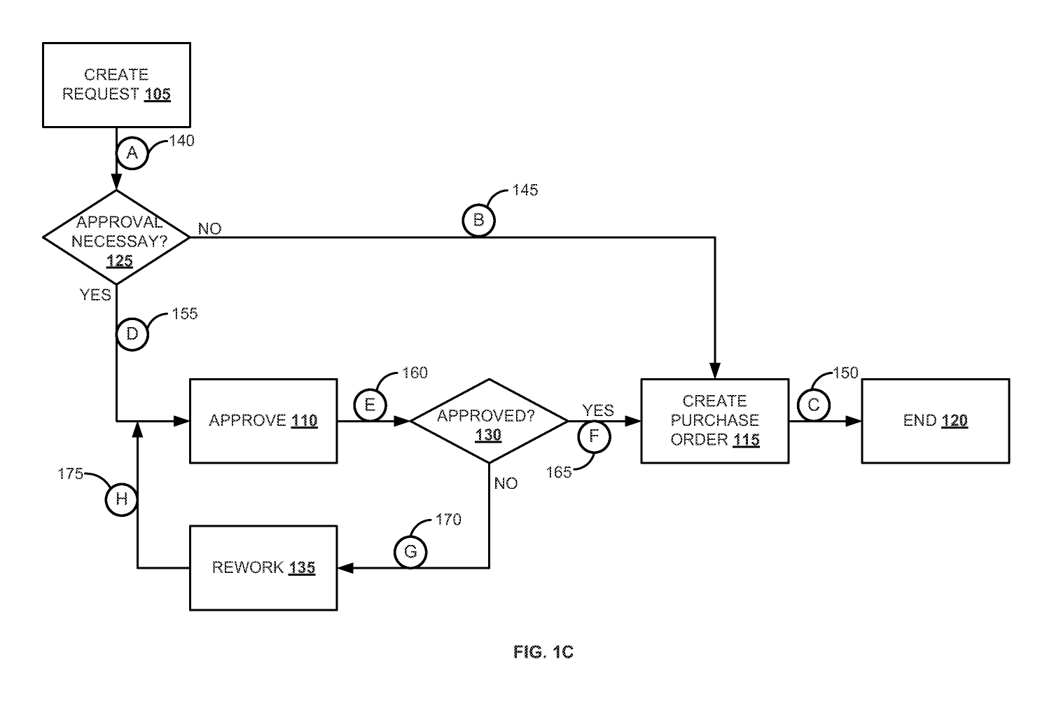

FIGS. 1A, 1B, and 1C are block diagrams representing exemplary methods of development of a trivial business process for purchase order approval. In the example shown, a company may need to introduce into its practice a business process for purchase order approval. FIG. 1A represents an initial business process definition for a purchase request that includes block Create request 105, an Approve 110 block, a Create purchase order 115 block, and End 120 block. After the request is initiated at block 105, then the process is straight forward through the approval at block Approve 110, following by creating the purchase order at block Create purchase order 115 and then the process ends at End 120 block. Here all created requests at block Create request 105 are forwarded to the approving authority at block Approve 110 and then the purchase order is created at block Create purchase order 115.

Then, due to, for example, a great number of requests, the company that introduced the business process presented in FIG. 1A may decide to change the initial business process by removing the need for approval of requests under a limit value. Thus, there will be no need for an approval of goods and services under a predefined limit value. Such kind of change requires change in the adopted business process definition presented in FIG. 1A. Hence, FIG. 1B represents a block diagram of an improved business process for a purchase order approval compared to FIG. 1A. The new block, which is an update to the previous business model definition in FIG. 1A, is the presence of a decision block Approval necessary 125 in FIG. 1B that checks, if an approval is needed by an approving authority. Thus, in FIG. 1B, after a request at block 105, a check will be performed at block Approval necessary 125 for the necessity of approving the purchase request. There may be different conditions for the necessity for approval. For example, the requirement for approval may depend on the position (rank) of the requester in the respective company, the location of the requester by country, region, etc. After the check is performed at block Approval necessary 125, then, depending on the necessity of approval, if an approval is necessary, the process continues at block Approve 110 for an approval by a respective authority and then, through the Create purchase order 115 block, the process ends at block End 120. In case no approval is necessary, which is determined at block Approval necessary 125, then the process goes directly to block Create purchase order 115 and then the process ends at block End 120, thus skipping the approval at block Approve 110. Such kind of change to the business process presented in FIGS. 1A and 1B, although a simple one, requires testing of all possible use cases.

A next iteration making the adopted business process even more complex is presented in FIG. 1C. The practice may bring the need for another check to the business process definition as shown in FIG. 1B, by introducing in FIG. 1C another check block Approved 130, determining if the purchase request is approved, and one more block Rework 135, giving options for the requester to rework his/her request and ask for approval again. The new, complicated business process as shown in FIG. 1C must be validated for consistency. A validation of the newly introduced functionality is a must as well as validating the behavior in all previous use cases. One testing approach is to record all previously successful use cases including the respective input and output data and then if a change in the adopted business process is implemented, together with checking the new features, all old and recorded used cases may be run for validation purposes.

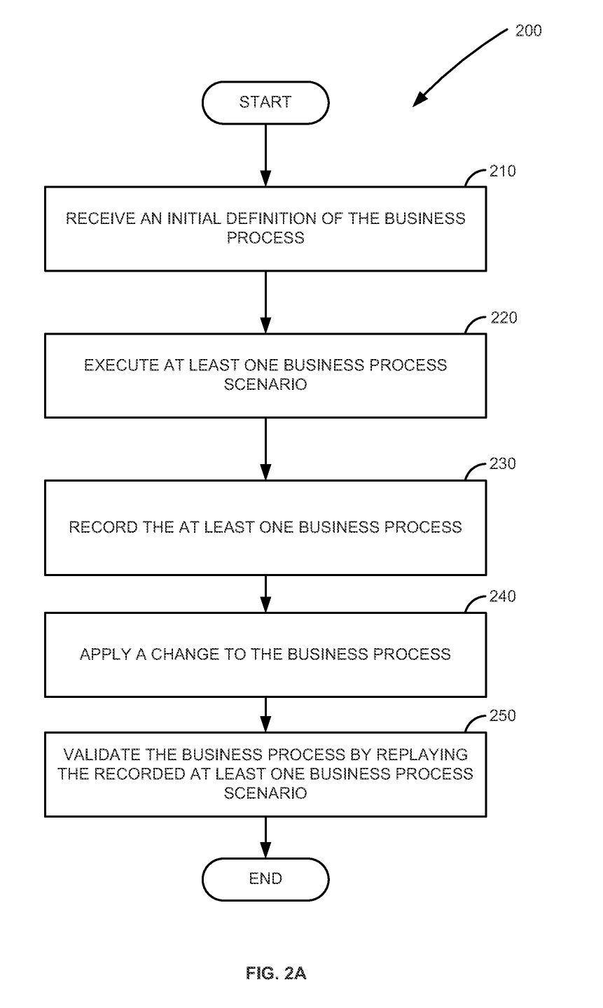

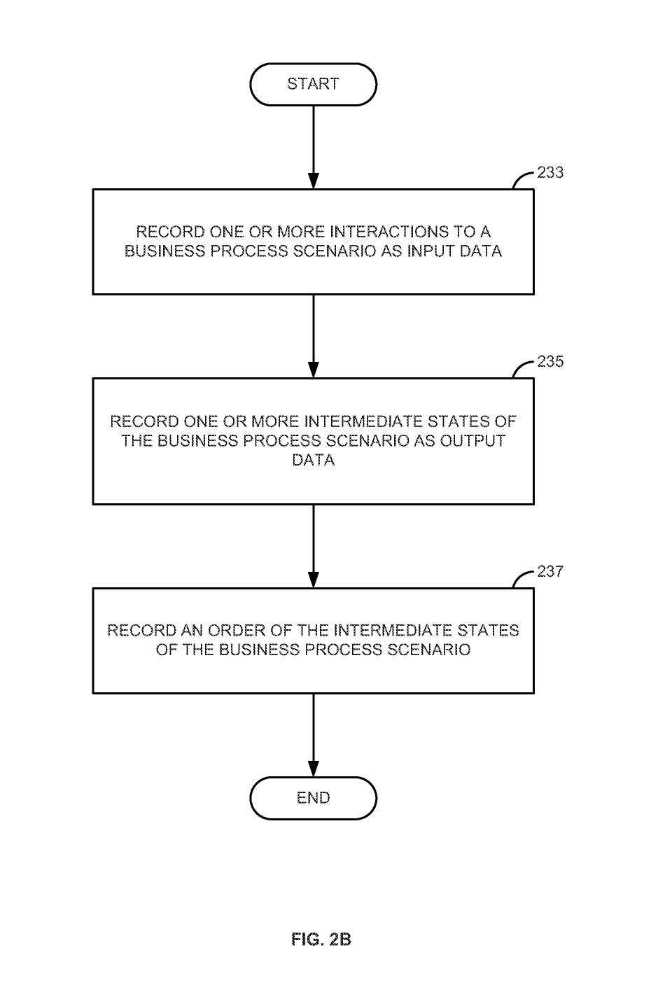

FIG. 2A is a flow diagram of an embodiment of a method 200 for regression testing of a business process. The method begins at block 210 with receiving an initial definition of the business process. The initial definition of the business process may be such as the definition shown in FIG. 1A.

Then, at block 220 at least one business process scenario is executed for the business process. The aim is to check if the business process definition behaves as expected.

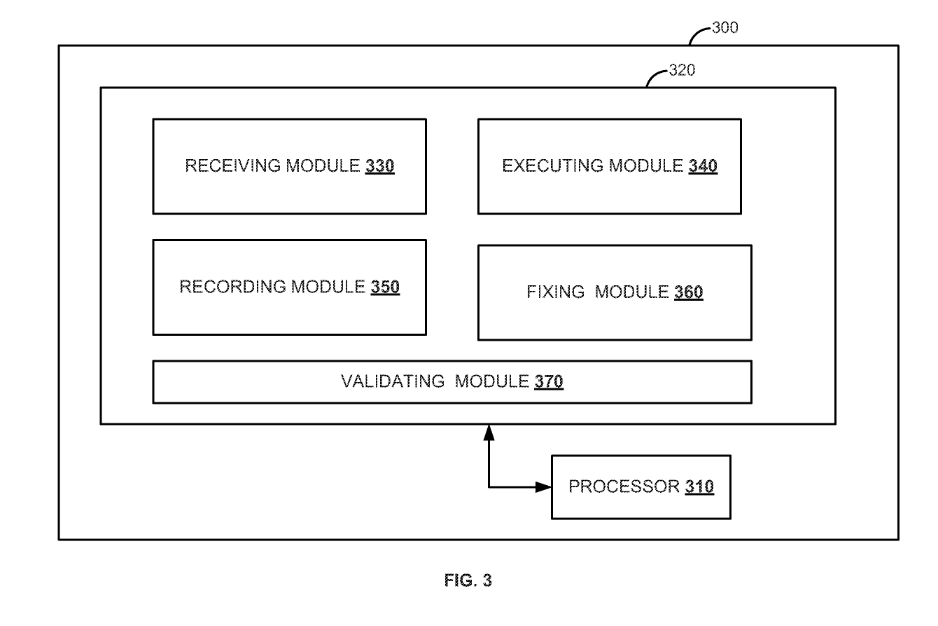

At block 230, the executed at least one business process scenario is recorded. Recorded scenarios may be used for future testing of the business process if any kind of change is introduced to the business process. In one embodiment, a scenario is recorded by recording one or more interactions specific to the at least one business process scenario as input data. Such interactions may be any kind of input data including human interactions and input data coming from external systems. The payload of data necessary to perform the scenario is recorded thus making an eventual later testing both user interface independent and external system independent. In one embodiment, together with the recordation of the interactions specific to the business scenario, one or more intermediate states of the scenario are recorded as output data for the respective scenario. The intermediate states are also referred to hereafter as checkpoints or just states. The intermediate states are the states that the scenario is expected to go through following the business process definition. In one embodiment, not only the intermediate states, but also the exact order of transition through the intermediate states is recorded for later testing purposes. For example, in a scenario following the business process definition presented in FIG. 1C, examples of intermediate states are states A 140, B 145, and C 150. These states are transitioned through in the scenario when no approval is necessary, which is determined at block Approval necessary 125. In such scenario, it is expected that the business process will go through exactly the states A 140, B 145, and C 150 and in the exact order presented. Another example is for the scenario, when an approval is necessary, which is defined in block Approval necessary 125 and then the request is approved, determined by block Approved 130. In this case the exact order of states is A 140, D 155, E 160, F 165, and C150. A third set of states for a third scenario using the business process definition shown in FIG. 1C may be A 140, D 155, E 160, G 170, H 175, E 160, F 165, and C 150. This is a scenario when the request is not approved at first at block Approved 130 and then follows the branch through blocks Rework 135. Approve 110 and again block Approved 130 until the purchase order is created at block Create purchase order 115 and the process ends at block End 120. Various combinations of transitions are possible through the states of a business process depending on the scenarios. The more complex the business process is, the more variations may exist for the orders the intermediate states may be transitioned through. Every order of intermediate states is defined by specific input data that determines a specific scenario. Thus the recorded intermediate states are defined based on a specification of the business process. In one embodiment, an expert validating the business process may define the intermediate states to be recorded following his own practice and expert evaluation. This allows a validator to set a specific set of intermediate states to be bound to specific input data, which is not exactly the set according to the specification of the business process for a specific scenario. For example, referring to FIG. 3C, the set of states A 140, B 145, and C 150 for the scenario when no approval is necessary may be reduced to A 140 and B 145, or even only the single state B 145. This is possible, because intermediate state B 145 is the crucial one for this scenario.

Turning back to FIG. 2A, at block 240, a change to the business process is applied. A change to the business process causes update to the initial definition of the business process. Any change to the business process requires validation of the performance of the updated business process including validation of all previously successful business scenarios.

At block 250, the business process is validated by replaying the recorded at least one business process scenario. In one embodiment, the validation is performed by replaying the recorded at least one business process scenario by using the recorded input data and checking the transition of the replayed at least one business process scenario through the recorded one or more intermediate states. Thus the validation is reduced to checking the consistency of input data (various interactions according to the scenario) with corresponding set of intermediate states (output data). As described above, in some embodiments is kept track of the exact order of transition through the intermediate states. In one embodiment, the order of the intermediate states is checked for the transition of the replayed at least one business process scenario through the recorded one or more intermediate states.

FIG. 2B is a flow diagram of an embodiment of a method for recording a business process scenario for regression testing. At block 233, one or more interactions to a business process scenario are recorded as input data. Such interactions may be any kind of input data including human interactions and input data coming from external systems. The payload of data necessary to perform the scenario is recorded thus making an eventual later both testing user interface independent and external system independent.

At block 235, one or more intermediate states of the business process scenario are recorded as output data. The intermediate states are the states that the scenario should go through following the business process definition. Thus the recorded intermediate states are defined based on a specification of the business process. In one embodiment, an expert validating the business process may define the intermediate states to be recorded following his own practice and expert evaluation. This allows a specific set of intermediate states to be bound to specific input data, which is not exactly the set according to the specification of the business process for a specific scenario.

At block 237, an order of the intermediate states of the business process scenario is recorded. Tracking the order of transition through intermediate states assures proper execution of a business process scenario. Every order of intermediate states is defined by specific input data that determines a specific scenario.

FIG. 3 is a block diagram of an embodiment of a system for regression testing of a business process. The system 300 includes a processor 310 for executing program code and memory 320 in communication with the processor. The system 300 also includes a receiving module 330, an executing module 340, a recording module 350, a fixing module 360 and a validating module 370, which are all within the memory 320.

The receiving module 330 is intended to receive an initial definition of a business process. The initial definition of the business process may be such as the definition shown in FIG. 1B.

The executing module 340 is intended to execute at least one business process scenario for the business process. The aim is to check if the business process definition behaves as expected and according to the requirements specified in a specification to the business process.

The recording module 350 is intended to record the at least one business process scenario for the business process. In one embodiment, the recording module 350 is operable to record one or more interactions specific to the at least one business process scenario as input data. Such interactions may be any kind of input data including human interactions and input data coming from external systems. The payload of data necessary to perform the scenario is recorded thus making an eventual later testing both user interface independent and external system independent. In one embodiment, together with the recordation of the interactions specific to the business scenario, the recording module 350 is operable to record one or more intermediate states of the scenario as output data for the respective scenario. The intermediate states are the states that the scenario is expected to go through following the business process definition. In one embodiment, the recording module is farther operable to record not only the intermediate states, but also the exact order of transition through the intermediate states. Every order of intermediate states is defined by specific input data that determines a specific scenario. Thus the recorded intermediate states are defined based on a specification of the business process. In one embodiment, an expert validating the business process may define the intermediate states to be recorded following his own practice and expert evaluation. This allows a specific set of intermediate states to be bound to specific input data, which is not exactly the set according to the specification of the business process for a specific scenario.

The fixing module 360 is intended to apply a change to the business process to update the initial definition of the business process. A change to the business process causes update to the initial definition of the business process. Any change to the business process requires validation of the performance of the updated business process including validation of all previously successful business scenarios.

The validating module 370 is intended to validate the business process by replaying the recorded at least one business process scenario. In one embodiment, the validating module 370 is operable to replay the recorded at least one business process scenario by using the recorded input data. In one embodiment, the validating module 370 is operable to check the transition of the replayed at least one business process scenario through the recorded one or more intermediate states. In yet another embodiment, the validating module is further operable to check the order of the intermediate states for the transition of the replayed at least one business process scenario through the recorded one or more intermediate states.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by compiler, and files containing higher-level code that are executed by a computer using an interpreter. For example, an embodiment may be implemented using Java®, C++, or other object-oriented programming language and development tools. Another embodiment may be implemented in hard-wired circuitry in place of or in combination with machine readable software instructions.

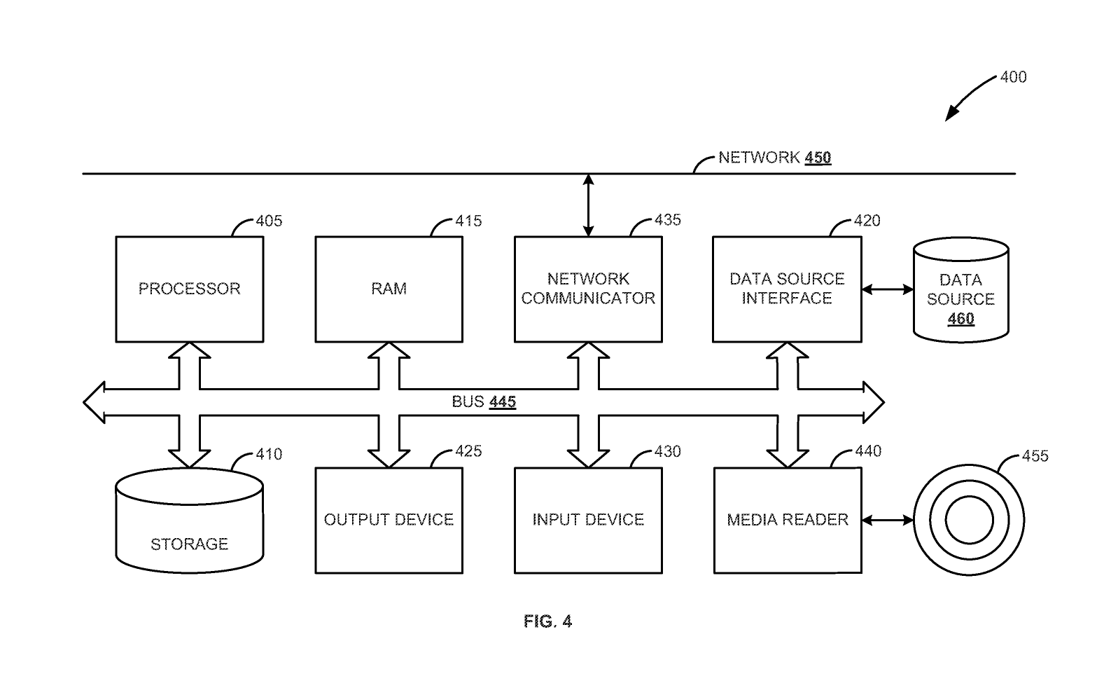

FIG. 4 is a block diagram of an exemplary computer system 400. The computer system 400 includes a processor 405 that executes software instructions or code stored on a computer readable storage medium 455 to perform the above-illustrated methods. The computer system 400 includes a media reader 440 to read the instructions from the computer readable storage medium 455 and store the instructions in storage 410 or in random access memory (RAM) 415. The storage 410 provides a large space for keeping static data where at least some instructions could be stored for later execution. The stored instructions may be further compiled to generate other representations of the instructions and dynamically stored in the RAM 415. The processor 405 reads instructions from the RAM 415 and performs actions as instructed. According to one embodiment, the computer system 400 further includes an output device 425 (e.g., a display) to provide at least some of the results of the execution as output including, hut not limited to, visual information to users and an input device 430 to provide a user or another device with means for entering data and/or otherwise interact with the computer system 400. Each of these output devices 425 and input devices 430 could be joined by one or more additional peripherals to further expand the capabilities of the computer system 400. A network communicator 435 may be provided to connect the computer system 400 to a network 450 and in turn to other devices connected to the network 450 including other clients, servers, data stores, and interfaces, for instance. The modules of the computer system 400 are interconnected via a bus 445, Computer system 400 includes a data source interface 420 to access data source 460. The data source 460 can be accessed via one or more abstraction layers implemented in hardware or software. For example, the data source 460 may he accessed by network 450. In some embodiments the data source 460 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), tiles, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

1. A computer implemented method for regression testing of a business process comprising:
receiving an initial definition of the business process in a receiving module of a computing system;
executing at least one business process scenario for the business process in an executing module of the computing system;
recording one or more interactions specific to the at least one business process scenario and a defined order of transition through one or more intermediate states specific to the at least one business process scenario in a recording module of the computing system, wherein the one or more intermediate states are bound to the one or more interactions; and
validating the business process by checking consistency of the one or more interactions specific to the at least one business process scenario with the defined order of transition through the one or more intermediate states in a validating module of the computing system.

2. The method of claim 1, wherein recording the at least one business process scenario further comprises:
recording the one or more interactions specific to the at least one business process scenario as input data in the recording module; and
recording the one or more intermediate states of the at least one business process scenario as output data in the recording module.

3. The method of claim 2, wherein the recorded one or more intermediate states are defined based on a specification of the business process.

4. The method of claim 2, wherein the recorded one or more intermediate states are defined based on an expert evaluation.

5. The method of claim 4, further comprising defining the one or more intermediate states of the at least one business process scenario to be bound to the one or more interactions based on the expert evaluation.

6. The method of claim 2, wherein validating the business process further comprises:
replaying the recorded at least one business process scenario by using the recorded one or more interactions as input data in the validating module; and
checking the defined order of transition of the replayed at least one business process scenario through the recorded one or more intermediate states in the validating module.

7. (canceled)

8. A computer system for regression testing of a business process comprising:
a processor; and
a memory in communication with the processor, the memory storing instructions related to:
a receiving module to receive an initial definition of the business process;
an executing module to execute at least one business process scenario for the business process;
a recording module to record one or more interactions specific to the at least one business process scenario and a defined order of transition through one or more intermediate states specific to the at least one business process scenario for the business process, wherein the one or more intermediate states are bound to the one or more interactions; and
a validating module to validate the business process by checking consistency of the one or more interactions specific to the at least one business process scenario with the defined order of transition through the one or more intermediate states.

9. The system of claim 8, wherein the recording module is further operable to:
record one or more interactions specific to the at least one business process scenario as input data; and
record one or more intermediate states of the at least one business process scenario as output data.

10. The system of claim 9, wherein the recorded one or more intermediate states are defined based on an expert evaluation.

11. The system of claim 9, wherein the recorded one or more intermediate states are defined based on a specification of the business process.

12. The system of claim 10, wherein the one or more intermediate states are bound to the one or more interactions based on the expert evaluation.

13. The system of claim 10, wherein the validating module is further operable to:
replay the recorded at least one business process scenario by using the recorded one or more interactions as input data; and
check the defined order of transition of the replayed at least one business process scenario through the recorded one or more intermediate states.

14. An article of manufacture including a non-transitory computer readable storage medium to tangibly store instructions, which when executed by a computer, cause the computer to:
receive an initial definition of a business process;
execute at least one business process scenario for the business process;
record one or more interactions specific to the at least one business process scenario and a defined order of transition through one or more intermediate states specific to the at least one business process scenario for the business process, wherein the one or more intermediate states are bound to the one or more interactions; and
validate the business process by checking consistency of the one or more interactions specific to the at least one business process scenario with the defined order of transition through the one or more intermediate states.

15. The article of manufacture of claim 14, wherein the instructions to record the at least one business process scenario for the business process further comprise instructions, which when executed by a computer, cause the computer to:
record one or more interactions specific to the at least one business process scenario as input data; and
record one or more intermediate states of the at least one business process scenario as output data.

16. The article of manufacture of claim 15, wherein the recorded one or more intermediate states are defined based on a specification of the business process.

17. The article of manufacture of claim 15, wherein the recorded one or more intermediate states are defined based on an expert evaluation.

18. The article of manufacture of claim 17, further comprising instructions, which when executed by a computer, cause the computer to define the one or more intermediate states to be bound to the one or more interactions of the at least one business process scenario based on the expert evaluation.

19. The article of manufacture of claim 18, wherein the instructions to validate the business process further comprise instructions, which when executed by a computer, cause the computer to:
replay the recorded at least one business process scenario by using the recorded one or more interactions as input data; and
check the defined order of transition of the replayed at least one business process scenario through the recorded one or more intermediate states.

20. (canceled)
